(19) United States
(12) Patent Application Publication
(10) Pub. No.: US 2011/0303208 A1
(43) Pub. Date: Dec. 15, 2011

(54) APPARATUS FOR PROJECTING AN OBJECT

(75) Inventor: Graeme John Taylor, Wolverhampton (GB)

(73) Assignee: China Industries Limited, Wolverhampton (GB)

(21) Appl. No.: 13/147,348

(22) PCT Filed: Feb. 1, 2010
(86) PCT No.: PCT/GB2010/050155

§ 371 Date: Aug. 23, 2011

(30) Foreign Application Priority Data
Jan. 31, 2009 (GB) 0901706.2

(51) Int. Cl. A63B 69/40; A01K 15/02

(52) U.S. Cl. 124/54; 119/707

(57) ABSTRACT

Apparatus for projecting an object such as a ball is described. The apparatus comprises a support for the object to be projected, an impeller assembly configured to transfer energy to the object to project it away from the apparatus; and an actuating mechanism operable by a user interaction with the apparatus. The impeller assembly may be driven mechanically by the actuating mechanism by transfer of energy input by the user interaction. The apparatus may be used for an animal and in particular a dog. The described apparatus removes the need for a further power supply and so avoids unnecessary energy consumption and provides advantages in relation to cost, reliability, and longevity. Embodiments of the invention are modular in nature which greatly assists in training the animal to use the apparatus.

The present invention relates to an apparatus for projecting or launching an object, such as a ball, and in particular to a mechanical device for projecting a ball. Embodiments of the invention have particular application to exercising animals such as dogs.

Many people enjoy interacting with animals and pets for companionship, relaxation and exercise. Dogs can make particularly agreeable pets due to their ability to be trained and their general playfulness. Many breeds of dog are natural retrievers, and games of chase or fetch, which involve a dog owner throwing an object such as a stick or ball to be chased and retrieved by the animal, are a popular way of playing with and exercising a dog.

However, the game requires repeated throwing by the dog owner, which can become tiring for the owner before the animal is sufficiently exercised. Enjoyment of the game may also be limited to the ability of the dog owner to throw the object a reasonable distance, which may be difficult for young, disabled, or elderly owners. Furthermore, some dog owners may be reluctant to handle an object which has accumulated dirt, water, or saliva from previous throwing and retrieval.

Various aids have been proposed to facilitate games of chase or fetch. These include throwing devices which effectively extend the length of the throwing arm to allow the object to be thrown further and/or with less effort. Some such devices include a formation which allows the object to be picked up for throwing without handling by the owner. Slings or catapults are also available for projecting an object significant distances with reduced effort. However, all such devices require repeated interaction of the owner with the dog, which may become tiresome or inconvenient in some circumstances. In addition, some dog owners may not be able to operate the devices effectively or safely. Catapult devices rely on highly elastic components designed to move at high velocity, and which may be hazardous in use.

More recently, there has been proposed an automatic ball dispenser which uses electronic components and sensors to launch a ball for retrieval by a dog. However, this device relies on a power source and electronic components for its operation, and is suitable only for indoor use.

It is amongst the objects of the invention to provide an apparatus for projecting an object which addresses one or more drawbacks of previously proposed apparatus. Another object of the invention is to provide an improved method of exercising or training an animal.

Additional aims and objects will become apparent from reading the following description.

### SUMMARY OF THE INVENTION

According to a first aspect of the invention, there is provided an apparatus for projecting an object, the apparatus comprising: a support for an object to be projected; an impeller assembly configured to transfer energy to the object to project it away from the apparatus; and an actuating mechanism operable by a user interaction with the apparatus; wherein the impeller assembly is operable to be driven mechanically by the actuating mechanism by transfer of energy input by the user interaction.

By providing an apparatus which is configured to transfer energy from the user interaction to drive the impeller and project the ball, the need for a further power supply or energy supply is avoided. Furthermore, use of electronic or electrical components may be avoided. The apparatus may be entirely mechanically operated. This avoids unnecessary energy consumption and provides advantages in relation to cost, reliability, and longevity. In addition, the apparatus has improved durability and robustness when compared with devices proposed in the prior art. This facilitates use and storage outside, for example in a garden, park or field.

Preferably the object is a ball.

The apparatus is preferably configured to be operated by an animal, such as a dog, to project an object. Thus the user may be an animal, and the apparatus may be a toy, a training device, or an exercise device for an animal (in particular a dog).

The actuation mechanism may comprise a plate or pad, which may be configured to be pressed by a user. Most preferably, the plate or pad is configured to be pressed by a dog. Preferably the plate or pad is detachably mounted to the apparatus.

The impeller assembly may comprise a rotating member, which may be a wheel and preferably is a flywheel. The rotating member may be configured for a rotation in a single direction.

The impeller assembly may comprise a coupling arrangement, which may comprise an arrangement of gears.

Preferably, the coupling arrangement includes a pinion and a resilient bias means. The resilient bias means may be mechanically attached to the impeller assembly and arranged so as to impart angular momentum to the impeller assembly in response to the energy input by the user.

A slot and pin mechanism may provide the attachment of the resilient bias means to a housing. Most preferably the slot comprises two or more recesses which provide a means for varying the tension of the resilient bias means.

Alternatively the coupling arrangement includes a rack and pinion system. Linear motion of the rack may be effected by the actuation mechanism.

The pinion may be rotationally coupled to the impeller assembly. In such an embodiment, the pinion may comprise a freewheel mounting to a rotating member of an impeller assembly. Alternatively, the pinion may coupled to a gear mounted to a rotating member of the impeller assembly.

In one embodiment, the coupling arrangement is movable from a first disengaged position (i.e. where it is not engaged with the impeller assembly) to an engaged position in which it drives the impeller assembly.

The apparatus may be configured such that movement of the rack causes a linear movement of the pinion from the disengaged position to the engaged position. An initial movement of the rack from its equilibrium position may move the pinion into engagement. Subsequent movement of the rack causes rotation of the pinion in its engaged position, thereby driving the impeller assembly.

The linear movement of the rack may be activated by a lever. The lever may be coupled to the actuating mechanism. Preferably, the movement of the pinion from the engaged position to a disengaged position may be due to gravity.

The apparatus may comprise a receptacle, which may be configured to receive an object. Preferably, the apparatus allows objects to be gravity-fed from the receptacle to a launching position on the support. The receptacle may be configured to allow passage of the object through the receptacle to a launching position on the support. The receptacle may be configured to receive multiple objects. Preferably the receptacle is detachably mounted to the apparatus.

Preferably, the apparatus is configured such that objects located in the receptacle and/or support are at least partially hidden from visibility. In particular, the objects may be shielded from the vision of an animal in use. This prevents or reduces the tendency for the animal to pick up objects direct from the support and/or the receptacle.

The impeller assembly may be configured to strike the object and project it from the apparatus. The impeller assembly may comprise at least one formation configured to strike the object. The apparatus may be configured to project the object into the air. Alternatively, the apparatus may be configured to project the object along the ground.

The formation may comprise an irregular surface, to facilitate projection of the object in different directions. In one embodiment, multiple formations are provided. Different formations may be provided with different shapes, such that they tend to project the object in different directions. Advantageously, the formation is configured to strike a point low on the object to project it into the air.

The actuating mechanism may comprise an equilibrium position, and may be configured such that movement from the equilibrium position drives the impeller assembly. The actuating mechanism may be configured to return to its equilibrium position. The apparatus may comprise one or more resilient members, to facilitate return of the actuating mechanism to its equilibrium position.

The apparatus may be configured such that the impeller assembly is driven for a period of time after the user interaction (which may be after the apparatus returns to its equilibrium position). This may be facilitated by use of a flywheel. Loading of an object in the apparatus after activation may still therefore allow the object to be launched.

According to a second aspect of the invention, there is provided an apparatus for projecting an object, the apparatus comprising: a support for an object to be projected; an impeller assembly configured to transfer energy to the object to project it away from the apparatus, and; an actuating mechanism operable by an animal; wherein the impeller assembly is operable to be driven mechanically by the actuating mechanism by energy input by the animal.

Embodiments of the second aspect of the invention may comprise features of the first aspect of the invention or its preferred or optional embodiments.

According to a third aspect of the invention, there is provided a method of exercising or entertaining an animal comprising:

locating an apparatus comprising a support; an impeller assembly and an actuating mechanism in a position accessible by the animal;
providing an object for location on the support;
allowing the animal to operate the actuating mechanism to drive the impeller assembly;
transferring energy from the impeller assembly to the object to project the object away from the apparatus.

According to a fourth aspect of the invention, there is provided a method of exercising or entertaining an animal comprising:

providing an apparatus comprising a support; an impeller assembly and an actuating mechanism;
providing an object for location on the support;
operating the actuating mechanism to drive the impeller assembly;
transferring energy from the impeller assembly to the object to project the object away from the apparatus.

In embodiments of the third or fourth aspects of the invention, the method may include the step of loading the apparatus with the object. The apparatus may be provided in a position accessible by the animal, to allow the animal to load the apparatus with the object. The method may include placing the object in a receptacle of the apparatus.

According to a further aspect of the invention, there is provided an apparatus for projecting an object, the apparatus comprising: a support for an object to be projected; an impeller assembly configured to transfer energy to the object to project it away from the apparatus, and; an actuating mechanism operable by a user interaction with the apparatus; wherein the impeller assembly is operable to be driven mechanically by the actuating mechanism by movement created by the user interaction.

Embodiments of the further aspect of the invention may comprise features of the first aspect of the invention or its preferred or optional embodiments.

Applications of the invention extend to use by humans and in particular children, and accordingly aspects of the invention include a method of exercising or training and a method of playing a game.

### BRIEF DESCRIPTION OF THE DRAWINGS

There will now be described, by way of example only, embodiments of the invention with reference to the drawings, of which:

FIG. 1 is a part sectional view of an apparatus in accordance with an embodiment of the invention;

FIG. 2 is a part sectional view through an operating part of the apparatus of FIG. 1 in a disengaged position;

FIG. 3 is a side view of the operating part of FIG. 2 in an engaged position;

FIG. 4 is a part sectional view of an apparatus in accordance with an alternative embodiment of the invention; and

FIG. 5 is a schematic representation showing the operation of the apparatus of FIG. 4.

### DETAILED DESCRIPTION

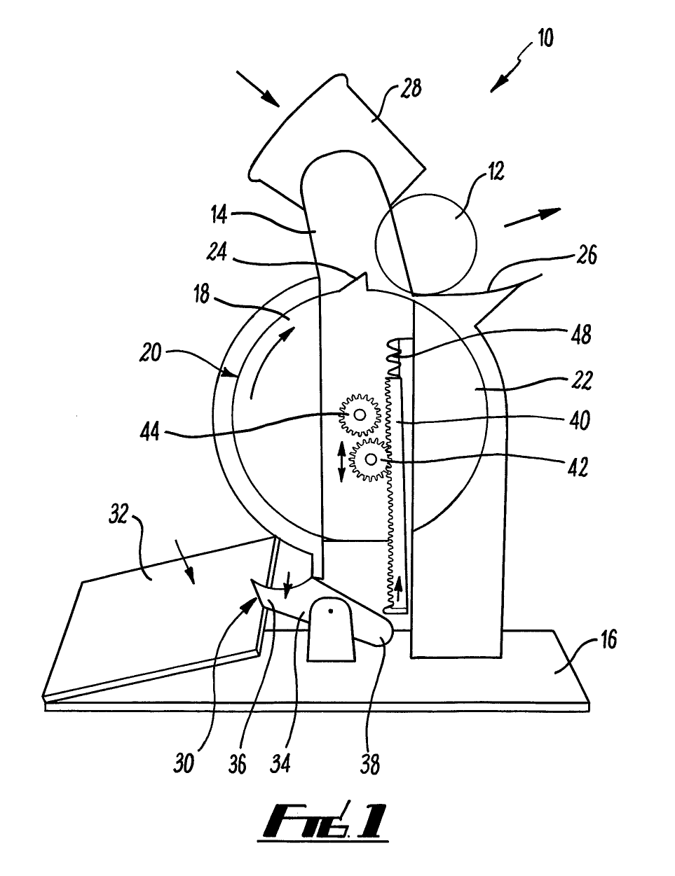

Referring firstly to FIG. 1, there is shown generally depicted at 10, an apparatus according to an embodiment of the invention. The apparatus is configured to project an object, which in this case is a ball 12, into the air. The apparatus comprises a frame 14 which supports the operating parts of the apparatus. The frame 14 comprises a base 16 and a housing 18 upstanding from the base 16. The housing 18 contains an impeller assembly, generally shown at 20, which comprises a flywheel 22 rotationally mounted to the frame 14. The flywheel comprises a formation 24 which extends radially from the flywheel 22. In this embodiment, the housing surrounds the flywheel, with sufficient clearance to prevent the formation 24 from touching the inner surface of the housing. Thus certain moving parts of the apparatus are not exposed during use, improving safety in operation and increasing robustness and resilience.

The apparatus also comprises a support member 26, arranged to support the ball 12 in a launch position, shown in FIG. 1. The ball 12 is gravity fed to the launch position on the support 26 from the receptacle 28. The receptacle 28 is in the form of a funnel having an inlet for an object and an outlet located above the support member 26.

The apparatus is also provided with an actuating mechanism, generally shown at 30. The actuating mechanism is in this embodiment provided on the base 16, and comprises a pressure plate 32 and a lever 34. In FIG. 1, the apparatus is shown in its equilibrium position, with the pressure plate 32 raised, and a first end 36 of the lever (proximal pressure plate 32) also raised. The lever 34 is pivoted near its centre, and the second end 38 of the lever 34 (which is distal the pressure plate 32) is lowered.

The apparatus comprises a coupling arrangement for transferring energy and movement from the actuating mechanism to the impeller assembly. In this embodiment, the coupling arrangement comprises a rack 40 and pinion 42, and the flywheel is provided with a gear 44 which is rotationally keyed with the flywheel. The rack and pinion co-operates with the actuating mechanism 30 and the impeller assembly 20.

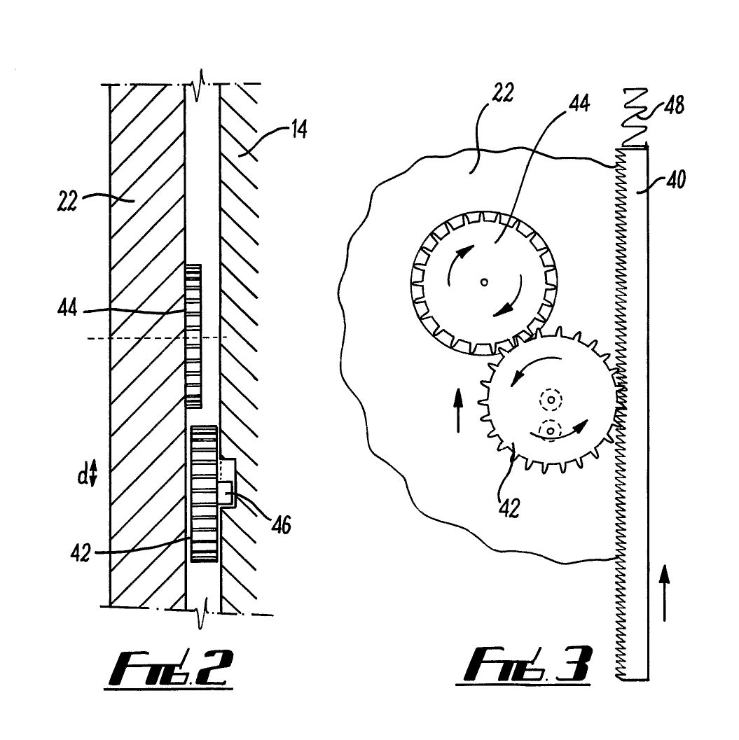

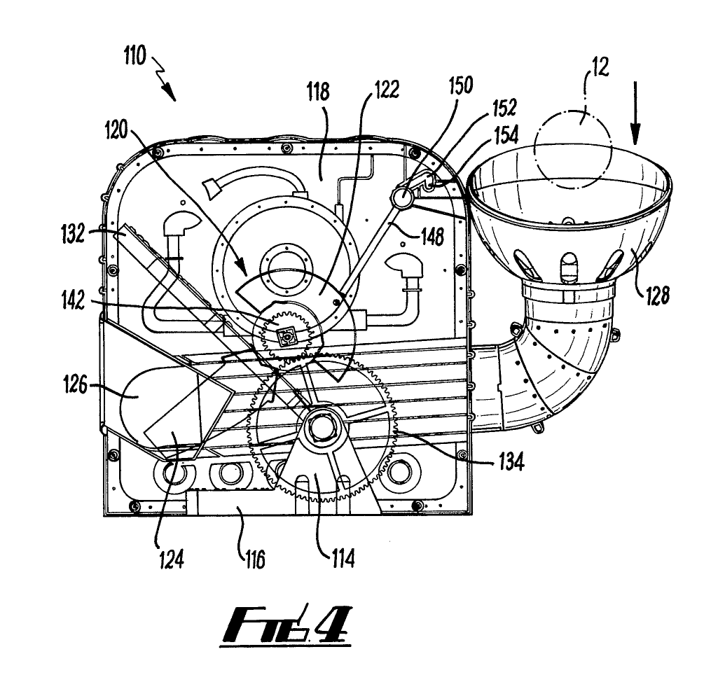

Operation of the apparatus is described with additional reference to FIGS. 2 and 3 of the drawings. FIG. 2 is a part-sectional view through a part of the coupling arrangement and flywheel 22 of the apparatus 10. FIG. 3 is a side view of the flywheel and coupling arrangement.

As shown in FIGS. 1 and 2, the pinion 42 is separated from the gear 44 in the equilibrium position of the apparatus. However, the pinion 42 is mounted to the frame 14 by a pin 46 such that it can move vertically a short distance to a position in which is engages the gear 44. The mounting is a clearance fit, such that initial upward movement of the rack 40 lifts the pinion 42 into the engaged position, shown in FIG. 3. Subsequent upward movement of the rack 40 causes rotation of the pinion 42, which drives rotation of the gear 44 and the flywheel 22 in a clockwise direction.

In use, the downward pressure is applied to the pressure plate 32, which causes the lever 34 to be operated. Upward movement of the second end 38 of the lever 34 imparts an upward force to the rack 40. This causes the pinion 42 to move into the engaged position, as described above, and further upward movement imparts a torque to the flywheel 22. When the pressure plate 32 is released, gravity causes the rack 40 and the pinion 42 to fall. After only a small movement by distance d, the pinion 42 become disengaged from the gear 44, and so the flywheel 22 is free to continue to rotate in the clockwise direction. Further downward movement of the rack causes rotation of the pinion 42, but because the pinion 42 is now disengaged from the gear 44, it has no effect on the flywheel 22. Downward movement of the rack 40, and therefore return to the equilibrium position of the apparatus, may be assisted by spring 48.

Thus the actuation of the mechanism by a force on the pressure plate 32 causes the flywheel 22 to rotate until the formation 24 passes the launch position. A ball 12 located on the support 26 in the launch position is struck by the formation 24 and is projected away from the apparatus 10 for an animal to chase and/or retrieve.

A principal advantage of the present invention is that it provides a projection apparatus that is operable by an animal, and in particular by a dog. The dog may operate the apparatus by standing on or otherwise depressing the actuation mechanism to project the ball. The dog can then chase and retrieve the ball. An alternative mode of use allows a dog owner to launch the ball by activating the apparatus.

The apparatus 10 is also configured to allow the animal to place the ball in the receptacle 28 to feed it back to the launch position for a subsequent projection, chasing and retrieval. The process can be repeated to allow the animal to entertain and exercise itself for extended periods without the necessity of intervention by an owner. The apparatus 10 is configured such that activation of the mechanism before loading of the apparatus with an object still results in the object being projected. Depression of the pressure plate during the loading or attempted loading by an animal will cause the flywheel to rotate. When the ball is in the launch position it will be struck by the formation 24 on the first rotation of the wheel.

Although the above-described embodiment describes use with a single ball, the invention extends to use with multiple objects. In such an embodiment, a receptacle and/or support may be provided with an increased capacity, to allow pre-loading with several balls or objects. This may be useful where it is difficult or impossible to train an animal to return the object to the receptacle for reloading and subsequent launch.

Although the embodiment of FIG. 1 shows the ball 12 for clarity, alternative embodiments obscure the ball from view, so that the animal does not attempt to pick up the ball direct from the support or receptacle prior to launch.

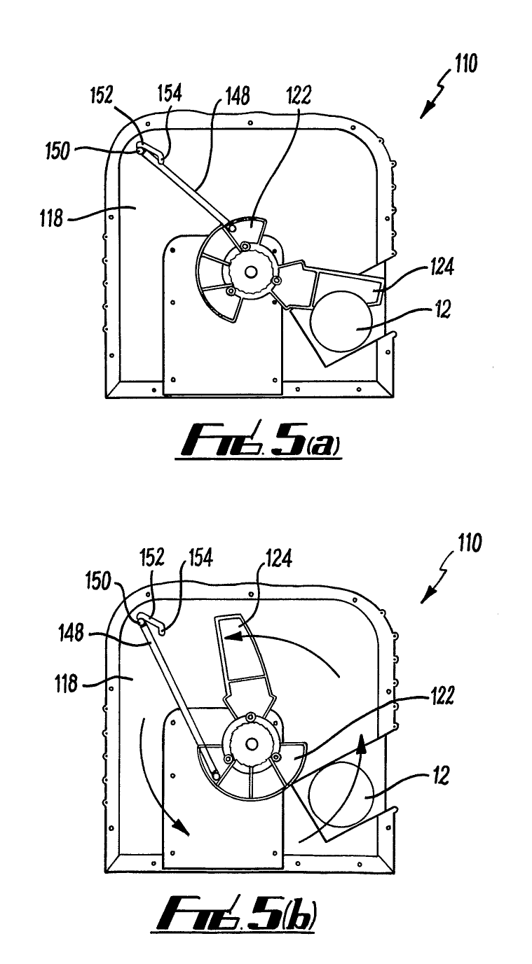

One such alternative embodiment apparatus 110 is presented in a part sectional view within FIG. 4. The apparatus comprises a frame 114 and housing 118 which support the operating parts of the apparatus 110. The frame 114 comprises a base 116 and a housing 118 upstanding from the base 116. The housing 118 contains an impeller assembly, generally shown at 120, which comprises a flywheel 122 rotationally mounted to the housing 118. The flywheel 122 comprises a formation 124 which extends radially from the flywheel 122. In this embodiment, the housing 118 again surrounds the flywheel 122, with sufficient clearance to prevent the formation 124 from touching the inner surface of the housing 118. Thus certain moving parts of the apparatus 110 are not exposed during use, improving safety in operation and increasing robustness and resilience.

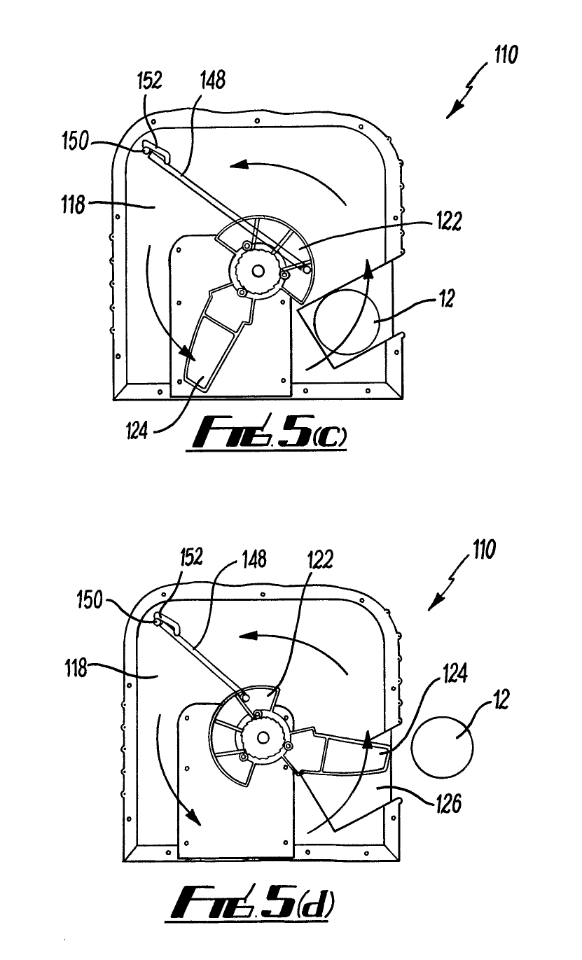

The apparatus 110 also comprises a support member 126, arranged to support the ball 12 in a launch position, as shown in FIG. 5(b). The ball 12 is gravity fed to the launch position on the support member 126 from a receptacle 128. The receptacle 128 is again in the form of a funnel having an inlet for an object and an outlet located to transfer the ball 12 to the support member 126.

The apparatus 110 is also provided with an actuating mechanism, generally shown at 130. The actuating mechanism 130 is in this embodiment provided on the base 116, and comprises a pressure plate 132 and an annular gear 134. In FIG. 4 and FIG. 5(a), the apparatus 110 is shown in its equilibrium position, with the pressure plate 132 spring biased within a raised position.

The apparatus 110 further comprises a coupling arrangement for transferring energy and movement from the actuating mechanism 130 to the impeller assembly 120. In this embodiment, the coupling arrangement comprises a resilient bias means 148, in the form of a spring, connected between the flywheel 122 and the housing 118 and a pinion 142 rotationally keyed with the flywheel 122.

The attachment of the spring 148 to the housing 118 is achieved via a pin 150 and slot 152 mechanism, the slot 152 comprising two recesses 154 so as to allow for the tension within the spring 148 to be varied. It will be appreciated that within alternative embodiments the length of the slot 152 and the number of recesses 154 may be altered so as to allow for increased variation of the tension within the spring 148.

The operation of this embodiment is described with reference to FIG. 5. It should be noted that some components of the apparatus 110 have been removed within the schematic representations of FIG. 5 for clarity of understanding.

FIG. 5(a) shows the apparatus 110 in its equilibrium position with a ball 12 located within the support member 126. In this position the formation 124 acts to retain the ball 12 in the correct position the support member so reducing the risk of jamming when multiple balls are deployed within the ball receptacle 128.

In use, the downward pressure is applied to the pressure plate 132, which causes the annular gear 134 to rotate. Since the annular gear 134 is connected to the flywheel 122 via the pinion 142 this downward pressure causes the flywheel 122 to rotate, as shown in FIG. 5(b). FIG. 5(c) shows the orientation of the flywheel 122 and the spring 148 when the pressure plate 132 has rotated from its raised position to a substantially horizontal position. At this time the tension in the spring 148 is at a maximum extension such that when the pressure plate 132 passes through the horizontal position of FIG. 5(c) the spring 148 acts to rapidly increase the angular momentum of the flywheel 122 and hence the formation 124. The formation 124 then strikes the ball 12 so as to impart the angular momentum from the formation 124 to the ball 12 resulting in the ball 12 being projected out of the apparatus 110, as presented in FIG. 5(d).

Once the downward pressure is removed from the pressure plate 132 the biased nature of the pressure plate 132 is such that it returns to its raised position. This is achieved without the mechanical engagement of the annular gear 134 and so there is no subsequent rotation of the fly wheel 122.

The incorporation of the spring 148 allows for the miniaturisation of the apparatus while still providing the necessary transfer of energy to project the ball 12 out of the support member 126. For example, a tennis ball will typically be projected 20 to 30 meters from the apparatus upon activation of the pressure plate 132.

The ball receptacle 128 and/or the pressure plate 132 may be removable from the apparatus 110. This modular nature of the apparatus 110 provides a means for an animal, such as a dog, to become familiar with these components in isolation. In this way the animal can be trained in isolation to place balls 12 in the ball receptacle 128 and to step on the pressure plate 132. For example upon receipt of a suitable command e.g. “load” and “fire”, respectively, if the dog successfully completes the required function they can be rewarded with a treat. Thus the modular nature of the apparatus 110 significantly increases the ability to train an animal to successfully operate the device.

Further alternative embodiments have formations on the flywheel of different shapes and angles to allow projection of objects at different angles to the horizontal, and in different directions from the apparatus. Some alternative embodiments of the apparatus of FIG. 1 may include multiple formations, which may be of different shapes, with the direction and elevation of the object dependent on which formation strikes the object.

A significant feature of the present invention is that the apparatus is powered by energy input by user interaction and in particular by animal interaction. The apparatus requires no power source, and no electronic or electrical components. This avoids unnecessary energy consumption and provides advantages in relation to cost, reliability, and longevity. In addition, the apparatus has improved durability and robustness when compared with devices proposed in the prior art. This facilitates use and storage outside, for example in a garden, park or field, in a variety of weather conditions. It will be appreciated that the invention encapsulates activation mechanisms, impeller assemblies and coupling arrangements other than that described in the specific embodiments of FIGS. 1 to 5. For example, in an alternative rack and pinion arrangement, the pinion may be rotationally coupled to the impeller assembly by a freewheel mounting. Different gearing rations can be used to provide an optimum transfer of torque. Cam mechanisms may be also employed.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. An apparatus for projecting an object, the apparatus comprising: a support for an object to be projected; an impeller assembly configured to transfer energy to the object to project it away from the apparatus; and an actuating mechanism operable by a user interaction with the apparatus; wherein the impeller assembly is operable to be driven mechanically by the actuating mechanism by transfer of energy input by the user interaction.

2. An apparatus for projecting an object as claimed in claim 1 wherein the object is a ball.

3. An apparatus for projecting an object as claimed in claim 1 wherein the apparatus is configured to be operated by an animal to project the object.

4. An apparatus for projecting an object as claimed in claim 1 wherein the actuation mechanism comprises a plate or pad configured to be pressed by the user.

5. An apparatus for projecting an object as claimed in claim 4 wherein the plate or pad is detachably mounted to the apparatus.

6. An apparatus for projecting an object as claimed in claim 1 wherein the impeller assembly comprises a rotating member.

7. An apparatus for projecting an object as claimed in claim 6 wherein the rotating member comprises a wheel.

8. An apparatus for projecting an object as claimed in claim 6 wherein the rotating member comprises a flywheel.

9. An apparatus for projecting an object as claimed in claim 6 wherein the rotating member is configured for a rotation in a single direction.

10. An apparatus for projecting an object as claimed in claim 1 wherein the impeller assembly comprises a coupling arrangement.

11. An apparatus for projecting an object as claimed in claim 10 wherein the coupling arrangement comprises an arrangement of gears.

12. An apparatus for projecting an object as claimed in claim 10 wherein the coupling arrangement includes a pinion and a resilient bias means.

13. An apparatus for projecting an object as claimed in claim 12 wherein the resilient bias means is mechanically attached to the impeller assembly and arranged so as to impart angular momentum to the impeller assembly in response to the energy input by the user.

14. An apparatus for projecting an object as claimed in claim 12 wherein a slot and pin mechanism provides for the attachment of the resilient bias means to a housing.

15. An apparatus for projecting an object as claimed in claim 14 wherein the slot comprises two or more recesses which provide a means for varying the tension of the resilient bias means.

16. An apparatus for projecting an object as claimed in claim 10 wherein the coupling arrangement includes a rack and pinion system.

17. An apparatus for projecting an object as claimed in claim 12 wherein the pinion is rotationally coupled to the impeller assembly.

18. An apparatus for projecting an object as claimed in claim 17 wherein the pinion comprises a freewheel mounting to a rotating member of an impeller assembly.

19. An apparatus for projecting an object as claimed in claim 18 wherein the pinion is coupled to a gear mounted to a rotating member of the impeller assembly.

20. An apparatus for projecting an object as claimed in claim 10 wherein the coupling arrangement is movable from a first disengaged position to an engaged position in which it drives the impeller assembly.

21. An apparatus for projecting an object as claimed in claim 20 wherein the apparatus is configured such that movement of the rack causes a linear movement of the pinion from the disengaged position to the engaged position.

22. An apparatus for projecting an object as claimed in claim 20 wherein an initial movement of the rack from the first disengaged position moves the pinion into engagement while subsequent movement of the rack causes rotation of the pinion in its engaged position, thereby driving the impeller assembly.

23. An apparatus for projecting an object as claimed in claim 16 wherein a linear movement of the rack may be activated by a lever.

24. An apparatus for projecting an object as claimed in claim 20 wherein the lever is coupled to the actuating mechanism.

25. An apparatus for projecting an object as claimed in claim 21 wherein movement of the pinion from the engaged position to a disengaged position is due to gravity.

26. An apparatus for projecting an object as claimed in claim 1 wherein the apparatus further comprises a receptacle configured to receive the object.

27. An apparatus for projecting an object as claimed in claim 26 wherein the apparatus allows the object to be gravity-fed from the receptacle to a launching position on the support.

28. An apparatus for projecting an object as claimed in claim 26 wherein the receptacle is configured to allow passage of the object through the receptacle to a launching position on the support.

29. An apparatus for projecting an object as claimed in claim 26 wherein the receptacle is configured to receive multiple objects.

30. An apparatus for projecting an object as claimed in claim 26 wherein the receptacle is detachably mounted to the apparatus.

31. An apparatus for projecting an object as claimed in claim 26 wherein the apparatus is configured such that objects located in the receptacle and/or support are at least partially hidden from visibility.

32. An apparatus for projecting an object as claimed in claim 1 wherein the impeller assembly is configured to strike the object and project it from the apparatus.

33. An apparatus for projecting an object as claimed in claim 32 wherein the impeller assembly comprises at least one formation configured to strike the object.

34. An apparatus for projecting an object as claimed in claim 1 wherein the apparatus is configured to project the object into the air.

35. An apparatus for projecting an object as claimed in claim 1 wherein the apparatus is configured to project the object along the ground.

36. An apparatus for projecting an object as claimed in claim 33 wherein the at least one formation comprises an irregular surface, to facilitate projection of the object in different directions.

37. An apparatus for projecting an object as claimed in claim 33 wherein multiple formations are provided and different formations are provided with different shapes, such that they tend to project the object in different directions.

38. An apparatus for projecting an object as claimed in claim 33 wherein the formations are configured to strike a point low on the object to project it into the air.

39. An apparatus for projecting an object as claimed claim 1 wherein the actuating mechanism comprises an equilibrium position.

40. An apparatus for projecting an object as claimed in claim 40 wherein the actuating mechanism is configured such that movement from the equilibrium position drives the impeller assembly.

41. An apparatus for projecting an object as claimed in claim 40 wherein the actuating mechanism is configured to return to the equilibrium position.

42. An apparatus for projecting an object as claimed in claim 41 wherein the apparatus further comprises one or more resilient members, to facilitate return of the actuating mechanism to its equilibrium position.

43. An apparatus for projecting an object as claimed in claim 1 wherein the apparatus is configured such that the impeller assembly is driven for a period of time after the user interaction.

44. A method of exercising or entertaining an animal comprising:
providing an apparatus comprising a support; an impeller assembly and an actuating mechanism;
providing an object for location on the support;
operating the actuating mechanism to drive the impeller assembly;
transferring energy from the impeller assembly to the object to project the object away from the apparatus.

45. A method of exercising or entertaining an animal as claimed in claim 44 wherein the method further comprises the step of loading the apparatus with the object.
